(19) United States
(12) Patent Application Publication
(10) Pub. No.: US 2025/0058908 A1
(43) Pub. Date: Feb. 20, 2025

(54) SUPPLY APPARATUS FOR FIXED AMOUNT OF WASHED RICE AND INSTANT RICE MANUFACTURING SYSTEM HAVING SAME

(71) Applicant: CJ CHEILJEDANG CORPORATION, Seoul (KR)

(72) Inventors: Soon Suk BAE, Chungcheongnam-do (KR); Sang Cheol KIM, Chungcheongnam-do (KR); Ui Cheol SHIN, Gwangju (KR); Sang Dong LEE, Chungcheongnam-do (KR); Hyun Cheol KONG, Seoul (KR); Beom Ho PARK, Seoul (KR)

(73) Assignee: CJ CHEILJEDANG CORPORATION, Seoul (KR)

(21) Appl. No.: 18/725,741

(22) PCT Filed: Nov. 18, 2022
(86) PCT No.: PCT/KR2022/018279

§ 371 Date: Jun. 28, 2024

(30) Foreign Application Priority Data
Dec. 30, 2021 (KR) 10-2021-0192907

(51) Int. Cl. B65B 1/06; A23L 7/196; B65B 1/36; B65B 25/02; B65G 47/19

(52) U.S. Cl. CPC B65B 1/06; A23L 7/1965; B65B 1/36; B65B 25/02; B65G 47/19; B65G 2201/0202; B65G 2814/0344

(57) ABSTRACT

Disclosed are a supply apparatus for a fixed amount of washed rice and an instant rice manufacturing system having same. The supply apparatus for a fixed amount of washed rice according to one embodiment of the present invention comprises: a washed rice hopper provided at one side of an apparatus body and forming a place where washed rice is stored therein; a plurality of upper chutes which are provided in the lower region of the washed rice hopper and through which the washed rice in the washed rice hopper falls individually; a plurality of lower chutes provided in the same number as the upper chutes, spaced apart from each other in the lower region of the upper chutes, and supplying the washed rice falling from the upper chutes to instant rice containers; and a washed rice delivery unit which is disposed between the upper chutes and the lower chutes, is at least partially movable, and simultaneously delivers the washed rice on the upper chute sides to the lower chutes.

### TECHNICAL FIELD

The present invention relates to a supply apparatus for a fixed amount of washed rice and an instant rice manufacturing system having the same, and more specifically, to a supply apparatus for a fixed amount of washed rice, whereby a fixed amount of washed rice can be filled in and supplied to a container and a complicated structure according to the related art can be efficiently and compactly simplified so that disassembly and assembly becomes easier and easy cleaning can be performed and thus an overall set up time can be reduced such that a production preparation time can be remarkably reduced, and an instant rice manufacturing system having the same.

### BACKGROUND ART

Rice is manufactured by pouring a predetermined amount of water into rice and heating the rice at the temperature of around 100° C. for about 30 minutes to 1 hour.

However, when you cook rice and store it without eating it right away, the moisture in the rice evaporates, the rice becomes hard, and the color of the rice changes into yellow, and thus it is difficult to eat the rice.

In addition, it is known that microorganisms exist on the surface of the rice, and although general microorganisms are killed during the cooking process, heat-resistant spores are not completely killed. Thus, it is not a problem when the rice is eaten within a day, but it becomes a problem when the rice is stored or distributed at room temperature for more than a day. In fact, lunch boxes sold packaged with side dishes are meant to be consumed within 7 hours from the time of manufacture.

In order to solve these problems, packaged instant rice that can be stored for a long time is being distributed on the market by reducing the number of microorganisms in the rice and killing heat-resistant spores.

This packaged instant rice tastes as good as freshly cooked rice once you heat the instant rice, so that the instant rice is used not only when traveling or on business trips, but also by people who have difficulty cooking meals on time, such as office workers, dual-income couples, or elderly people.

The typical instant rice manufacturing process includes an instant rice container insertion process, a sterilization process of sterilizing the rice in the container, a cooking process of heating and cooking the rice, a sealing process of placing a lid on the container, a post-treatment process such as sterilization and cooling of the container, and the like.

Among these processes, the instant rice container insertion process may be performed in the following order: separately supplying an instant rice container, container presence detection, container foreign substance removal, supplying a fixed amount of washed rice, chopping the washed rice, and container discharging, etc.

Meanwhile, among the above processes, the supplying of the fixed amount of washed rice is a process of supplying (filling) a fixed amount of washed rice to a container, as described above, and to this end, a so-called apparatus for supplying a fixed amount of washed rice is used.

The currently mainstream apparatus for supplying a fixed amount of washed rice is a volumetric measurement method using a volume meter, also called a mas (hop or doe). In the volumetric measurement method according to the prior art, rice is placed in the space of the volume meter and when the volume meter moves forward, the rice falls into a front chute and returns to its original position and the rice is placed in the space of the volume meter and when the volume meter moves backward, the rice falls into a rear chute.

This volumetric measurement method is currently the mainstream in production facilities, but in the case of existing related art, a plurality of individual volumetric meters, for example, seven, are generally configured, so that the structure of the volumetric meter is complicated. That is, considering that the nature of food equipment requires complete disassembly and cleaning at least once a day, an apparatus for supplying a fixed amount of washed rice according to the related art not only has too many disassembly items due to complicated structural limitations, but also has a complicated disassembly method, and thus, it is difficult to perform cleaning, and it takes a long time to prepare for production, and there is a problem in that it takes a lot of set up time because quantity adjustment needs to be done individually.

### PRIOR ART DOCUMENT

### [Patent Document]

(Patent Document 1) Korean Patent Registration No. 10-0726155 (Jun. 1, 2007)

### DISCLOSURE

### Technical Problem

The present invention provides a supply apparatus for a fixed amount of washed rice, whereby a fixed amount of washed rice can be filled in and supplied to a container and a complicated structure according to the related art can be efficiently and compactly simplified so that disassembly and assembly becomes easier and easy cleaning can be performed and thus an overall set up time can be reduced such that a production preparation time can be remarkably reduced, and an instant rice manufacturing system having the same.

### Technical Solution

According to an aspect of the present invention, there is provided a supply apparatus for a fixed amount of washed rice, the supply apparatus including: a washed rice hopper provided at one side of an apparatus body and forming a place where washed rice is stored therein; a plurality of upper chutes which are provided in a lower region of the washed rice hopper and through which the washed rice in the washed rice hopper falls individually; a plurality of lower chutes provided in a same number as the upper chutes, spaced apart from each other in a lower region of the upper chutes, and supplying the washed rice falling from the upper chutes to instant rice containers; and a washed rice delivery unit which is disposed between the upper chutes and the lower chutes, is at least partially movable, and simultaneously delivers the washed rice on the upper chute sides to the lower chutes.

The washed rice delivery unit may include: a plurality of washed rice storing units which are arranged in a lower region of the upper chutes while respectively corresponding to the upper chutes and in which washed rice falling from the upper chutes is temporarily stored; an integrated volumetric unit which is disposed in a lower part of the washed rice storing unit, linearly moves and delivers washed rice at the washed rice storing unit to the lower chutes; and a volumetric unit driving unit connected to the integrated volumetric unit and driving the integrated volumetric unit linearly.

The washed rice delivery unit may further include a washed rice delivery plate which is arranged between the integrated volumetric unit and the lower chutes and includes a plurality of washed rice delivery holes through which washed rice at the integrated volumetric unit is delivered to the lower chutes.

The washed rice delivery unit may further include a unit guide which is disposed on the washed rice delivery plate and guides linear movement of the integrated volumetric unit.

The washed rice delivery unit may further include a stopper which is disposed in front of or in rear of the unit guide and limits movement of the integrated volumetric unit.

The integrated volumetric unit may include: a unit body which divides a space in which a fixed amount of washed rice is individually stored, has a plurality of spacing adjusters arranged to be adjustable therein and of which upper and lower parts are perforated; an upper plate which is detachably coupled to the upper part of the unit body and has a plurality of upper through holes formed therein; and a lower plate which is detachably coupled to the lower part of the unit body and has a plurality of lower through holes formed therein.

The integrated volumetric unit may further include: a head portion coupled to one end of the unit body; and a spacing adjustment bolt which is connected to the head portion and the unit body and adjusts a distance between the head portion and the unit body.

The integrated volumetric unit may further include a driving unit connection bracket coupled to the other end of the unit body and connected to the volumetric unit driving unit.

The supply apparatus may further include a device controller controlling an operation of the washed rice delivery unit with respect to the volumetric unit driving unit so that a fixed amount of washed rice in the washed rice hopper can be supplied to the container through the upper chutes, the washed rice delivery unit, and the lower chutes.

According to another aspect of the present invention, there is provided an instant rice manufacturing system including: a system body; and a supply apparatus for a fixed amount of washed rice which is provided at one side of the system body and supplies a fixed amount of washed rice into an instant rice container, wherein the supply apparatus for a fixed amount of washed rice includes: a washed rice hopper provided at one side of an apparatus body and forming a place where washed rice is stored therein; a plurality of upper chutes which are provided in a lower region of the washed rice hopper and through which the washed rice in the washed rice hopper falls individually; a plurality of lower chutes provided in a same number as the upper chutes, spaced apart from each other in a lower region of the upper chutes, and supplying the washed rice falling from the upper chutes to instant rice containers; and a washed rice delivery unit which is disposed between the upper chutes and the lower chutes, is at least partially movable, and simultaneously delivers the washed rice on the upper chute sides to the lower chutes.

### Advantageous Effects

According to the present invention, a fixed amount of washed rice can be filled in and supplied to a container and a complicated structure according to the related art can be efficiently and compactly simplified so that disassembly and assembly becomes easier and easy cleaning can be performed and thus an overall set up time can be reduced such that a production preparation time can be remarkably reduced.

### BRIEF DESCRIPTION OF THE DRAWING

FIG. 1 is a schematic configuration diagram of an instant rice manufacturing system according to an embodiment of the present invention;

FIG. 2 is a usage state diagram of a supply apparatus for a fixed amount of washed rice according to an embodiment of the present invention;

FIG. 3 is a perspective view of the supply apparatus for a fixed amount of washed rice shown in FIG. 2;

FIGS. 4 through 6 are diagrams illustrating the supply apparatus for a fixed amount of washed rice of FIG. 3 at different angles;

FIG. 7 is a view in which an apparatus body is removed from FIG. 3;

FIG. 8 is a bottom view of FIG. 7;

FIGS. 9 and 10 are partially exploded view of FIGS. 7 and 8, respectively;

FIG. 11 is a perspective view of a washed rice delivery unit;

FIG. 12 is a bottom view of FIG. 11;

FIG. 13 is a view in which a washed rice removal unit is removed from FIG. 11;

FIG. 14 is a perspective view of an integrated volumetric unit;

FIG. 15 is an enlarged perspective view of FIG. 14;

FIG. 16 is a cut perspective view of FIG. 14; and

FIG. 17 is a control block diagram of a supply apparatus for a fixed amount of washed rice according to an embodiment of the present invention.

### DETAILED DESCRIPTION OF PREFERRED EMBODIMENTS

In order to fully understand the present invention, operational advantages of the present invention, and the objectives achieved by practicing the present invention, the accompanying drawings illustrating preferred embodiments of the present invention and the contents described in the accompanying drawings should be referred to.

Hereinafter, preferred embodiments of the present invention will be described in detail with reference to the exemplary drawings. Like reference numerals in each of the drawings represent like elements.

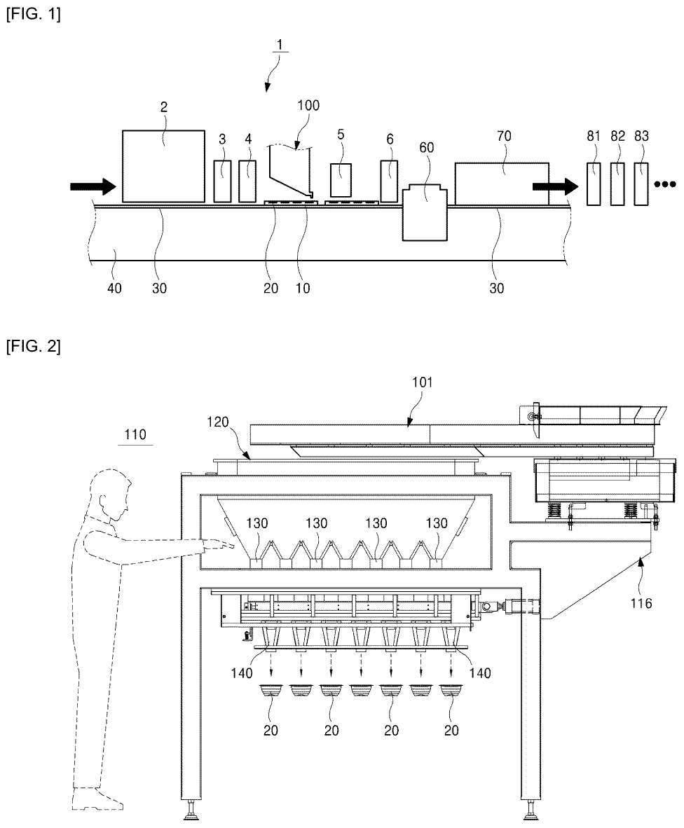

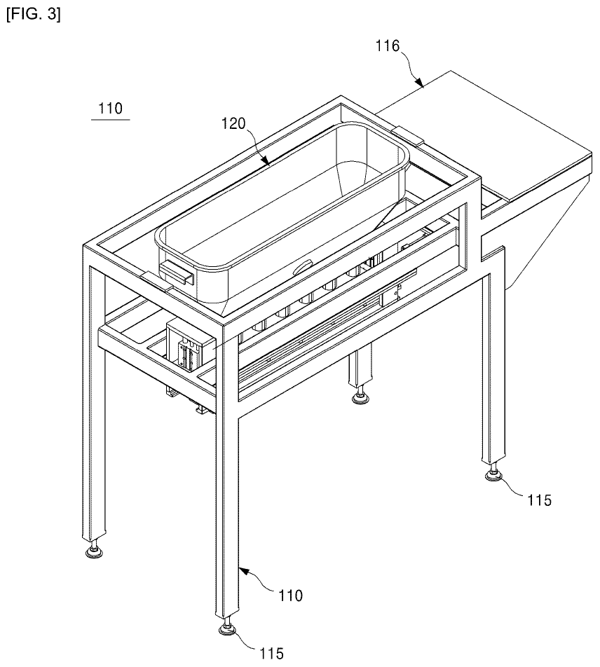

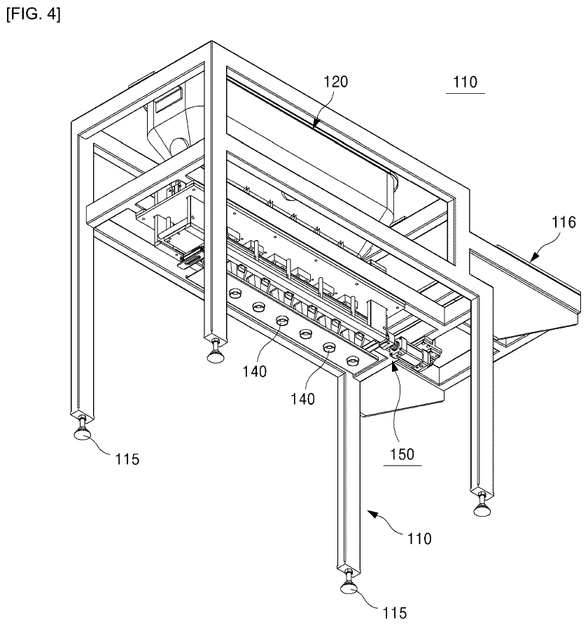

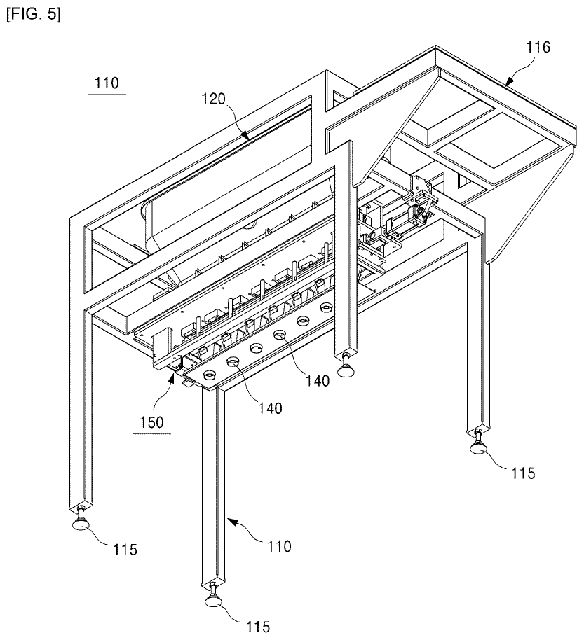

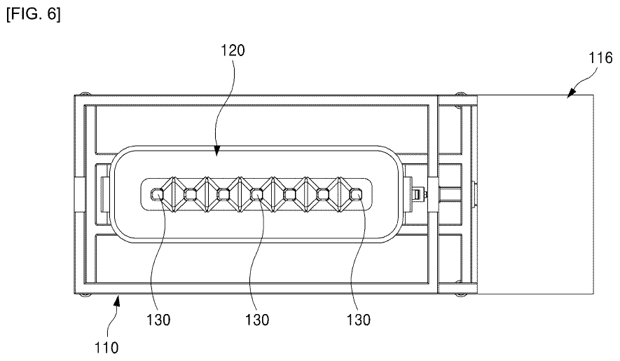

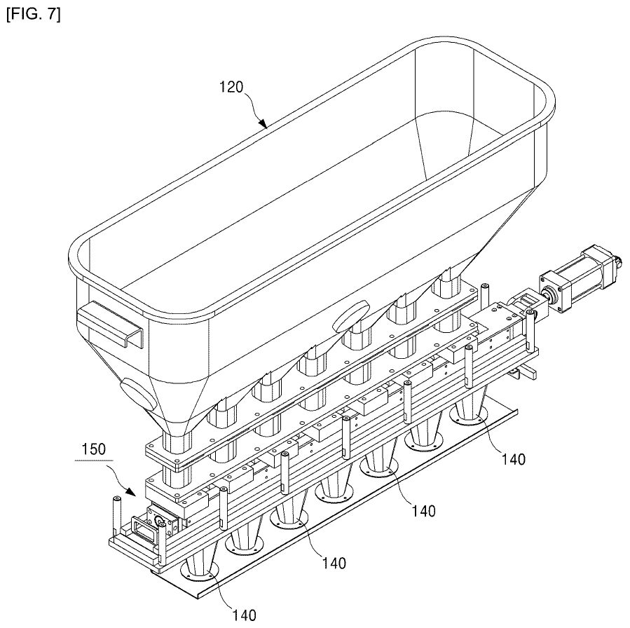

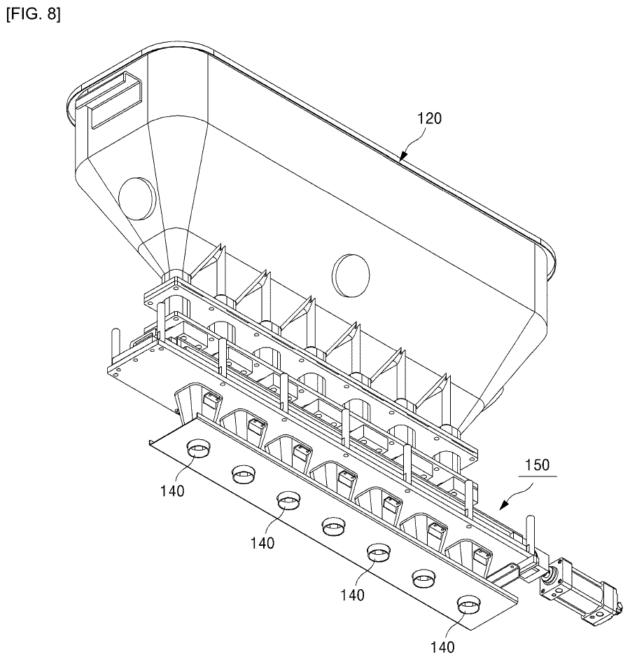

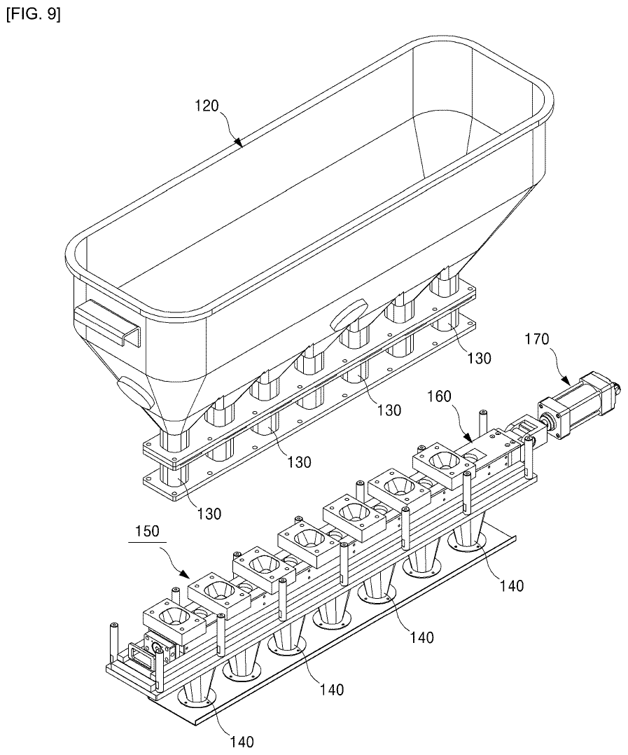

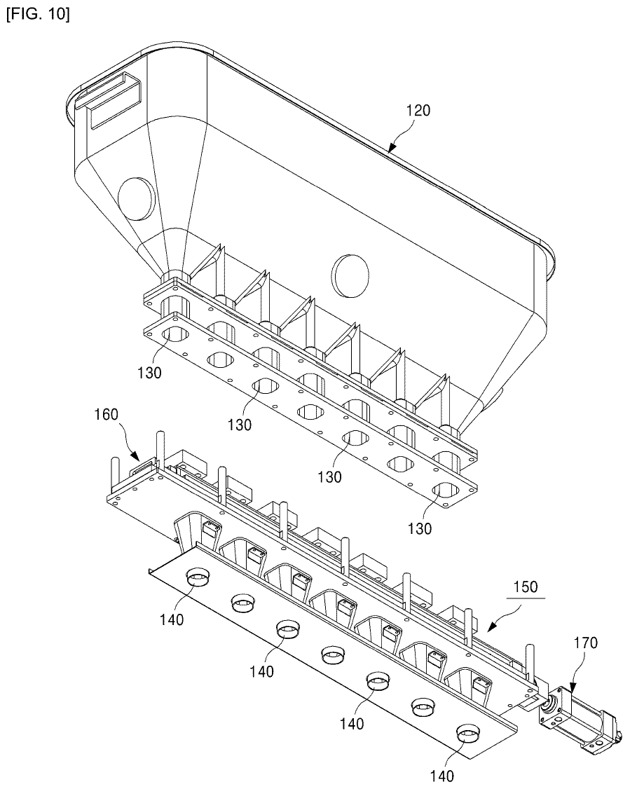

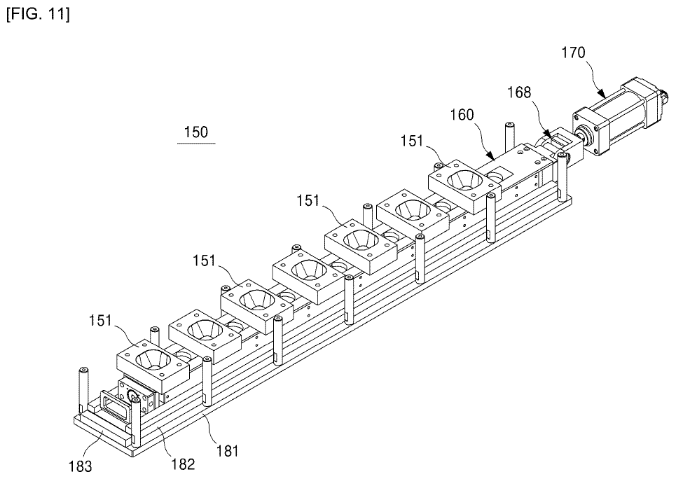

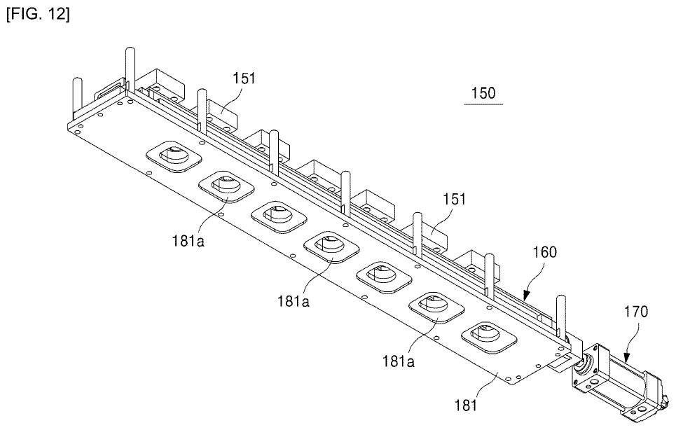

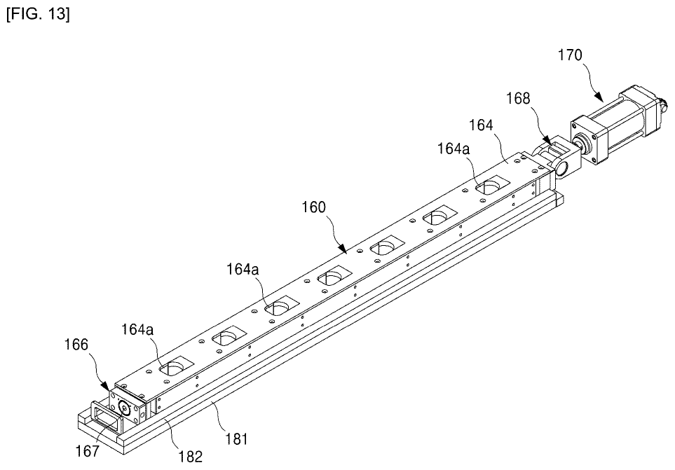

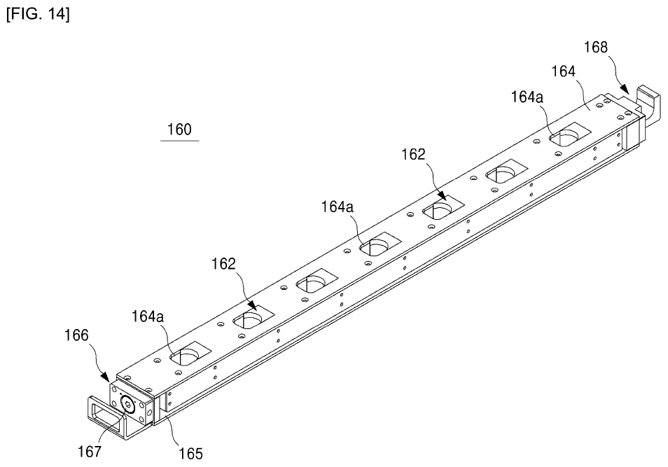

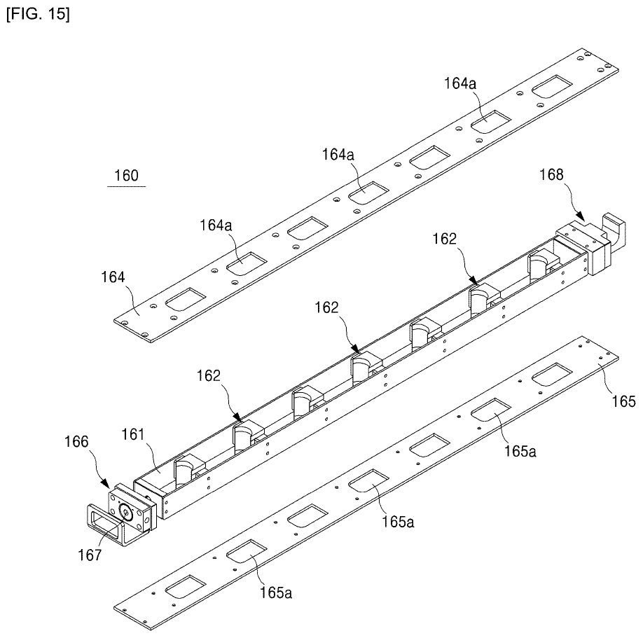

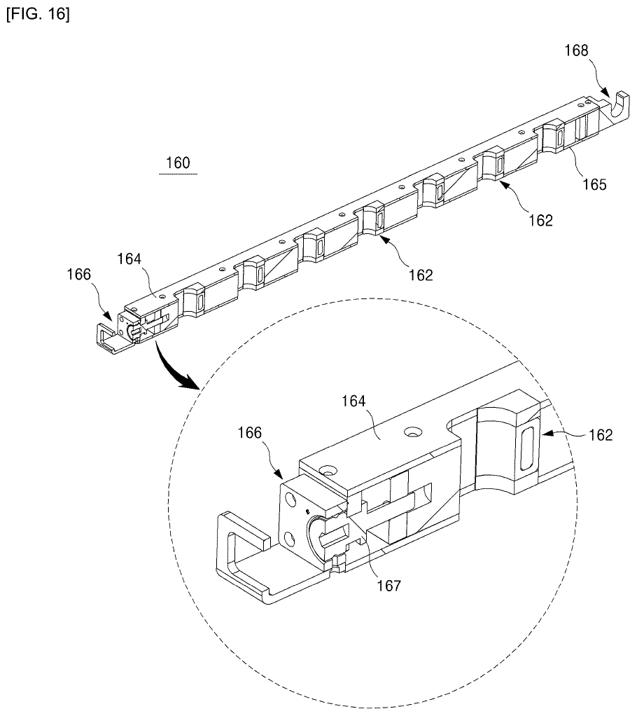

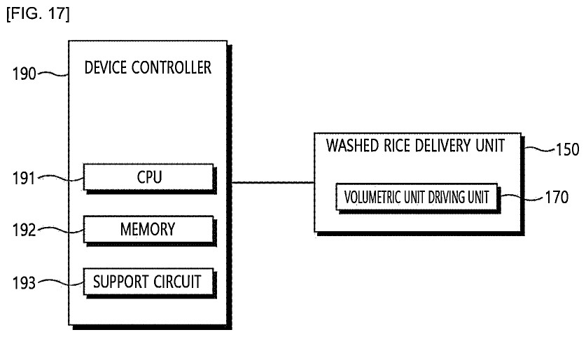

FIG. 1 is a schematic configuration diagram of an instant rice manufacturing system according to an embodiment of the present invention, FIG. 2 is a usage state diagram of a supply apparatus for a fixed amount of washed rice according to an embodiment of the present invention, FIG. 3 is a perspective view of the supply apparatus for a fixed amount of washed rice shown in FIG. 2, FIGS. 4 through 6 are diagrams illustrating the supply apparatus for a fixed amount of washed rice of FIG. 3 at different angles, FIG. 7 is a view in which an apparatus body is removed from FIG. 3, FIG. 8 is a bottom view of FIG. 7, FIGS. 9 and 10 are partially exploded view of FIGS. 7 and 8, respectively, FIG. 11 is a perspective view of a washed rice delivery unit, FIG. 12 is a bottom view of FIG. 11, FIG. 13 is a view in which a washed rice removal unit is removed from FIG. 11, FIG. 14 is a perspective view of an integrated volumetric unit, FIG. 15 is an enlarged perspective view of FIG. 14, FIG. 16 is a cut perspective view of FIG. 14, and FIG. 17 is a control block diagram of a supply apparatus for a fixed amount of washed rice according to an embodiment of the present invention.

Referring to these drawings, but first to FIG. 1, the instant rice manufacturing system according to the present embodiment may include a system body 40, a tray conveyor 30 movably coupled to the system body 40, a tray 10 which is loaded onto the tray conveyor 30 and moves along the tray conveyor 30 and on which a container 20, i.e., an instant rice container 20 is mounted, an instant rice container insertion unit 1 for inserting the instant rice container 20, a steam pressurizing sterilization device 60 that pressurizes and sterilizes the container 20 filled with rice grains with steam, and a cooking device 70 for cooking rice.

Of course, a sealing device 81 which is provided in a process after the cooking device 70 and in which a lid (not shown) is placed on the container 20, a treatment device 82 for sterilizing and cooling the container 20, and a packaging device 83 for packaging may also be one component of the instant rice manufacturing system according to the present embodiment.

The instant rice container insertion unit 1 may include a combination of devices performing several processes. In other words, in the present embodiment, the instant rice container insertion unit 1 may include an instant rice container separation device 2 according to the present embodiment that separates and supplies the instant rice container 20 in a stacked state, a container presence detection device 3 that detects whether the container 20 is supplied in a supply line or not, a container foreign substance removal device 4 that removes foreign substances in the container 20, a supply apparatus 100 for a fixed amount of washed rice that supplies a fixed amount of washed rice into the container 20, a washed rice chopping device 5 that chops the fixed amount of washed rice, and a container discharge device 6 that discharges the container 20 in which the fixed amount of washed rice is supplied and a chopping work is completed.

The above-described tray conveyor 30, and a motor device for driving the tray conveyor 30 may be mounted in the system body 40 of the instant rice manufacturing system according to the present embodiment so that a continuous automatic process using these devices can be performed.

For your reference, FIG. 1 is a very schematic configuration diagram of the instant rice manufacturing system according to the present embodiment, for example, one steam pressurizing and sterilization device 60 has been applied to the instant rice manufacturing system. However, the number of steam pressurizing and sterilization devices 60 may be two or more. When a plurality of steam pressurizing and sterilization devices 60 are arranged, a sterilization process can be efficiently and more quickly performed.

Of course, considering that the cooking device 70 requires a considerable time, other devices including the cooking device 70 may be applied in plurality. Thus, the scope of rights of the present invention is not limited to the shape of the drawings.

Thus, after a container separation supply process for separating and supplying instant rice containers through the instant rice container insertion unit 1, a container presence detection process, a container foreign substance removal process, a fixed amount of washed rice supply process, a washed rice chopping process, and a container discharge process are sequentially performed, the container 20 is pressurized and sterilized with steam through the steam pressurizing and sterilization device 60 and then rice may be cooked by the cooking device 70. Thereafter, after the container 20 is covered with a lid, the container 20 is sterilized and cooled, and then packaged and released as a product.

Meanwhile, among these processes, in particular, the instant rice container insertion process may be performed through the instant rice container insertion unit 1, and the instant rice container insertion unit 1 is equipped with the supply apparatus for a fixed amount of washed rice according to the present embodiment.

Of course, an apparatus for supplying washed rice has been applied, but in the case of the related art, as described above, it was a volumetric measurement method using a so-called complex individual volume meter and thus, due to its structural limitations, not only there are too many disassembly items, but also a disassembly method is complicated, which results in making cleaning difficult and it takes a long time to prepare for production and in addition, a setup time takes a long time because quantity adjustment had to be done individually.

Thus, the present embodiment proposes the supply apparatus 100 for a fixed amount of washed rice having an efficient and compact structure as described below so as to solve these problems.

When the supply apparatus 100 for a fixed amount of washed rice according to the present embodiment is applied, a fixed amount of washed rice can be filled in and supplied to the container 20, and a complicated structure according to the related art can be efficiently and compactly simplified so that disassembly and assembly becomes easier and easy cleaning can be performed and thus, an overall set up time a production preparation time can be remarkably reduced, can be reduced.

The supply apparatus 100 for a fixed amount of washed rice according to the present embodiment capable of providing these effects includes an apparatus body 110, and has a shape in which the following components, i.e., a washed rice hopper 120, an upper chute 130, a lower chute 140 and a washed rice delivery unit 150 are mounted on the apparatus body 110 according to positions.

The apparatus body 110 that is an exterior structure of the supply apparatus 100 for a fixed amount of washed rice according to the present embodiment supports the washed rice hopper 120, the upper chute 130, the lower chute 140, and the washed rice delivery unit 150. Thus, the apparatus body 110 is manufactured of a metallic material having excellent rigidity.

A height adjustment foot 115 is provided at a lower part of the apparatus body 110. Also, a feeder mounting unit 116 for mounting a linear feeder 101 shown in FIG. 2 is provided at one side of the apparatus body 110.

The washed rice hopper 120 is provided at one side of the apparatus body 110 and constitutes a place in which washed rice is stored. An upper end of the washed rice hopper 120 has an elliptical structure, and the width of a lower end of the washed rice hopper 120 decreases gradually.

The upper chute 130 is provided in a lower region of the washed rice hopper 120 and constitutes a path on which washed rice in the washed rice hopper 120 falls individually. The lower chute 140 is provided with the same number as the upper chute 130, is spaced apart from a lower region of the upper chute 130, and constitutes a path on which washed rice falling from the upper chute 130 is supplied to instant rice containers 20.

In the present embodiment, the upper chutes 130 and the lower chutes 140 each having seven holes provided. Thus, a fixed amount of washed rice may be supplied to seven containers 20 for one cycle. Of course, the scope of rights of the present invention is not limited to this number. Thus, the number of holes of each of the upper chutes 130 and the lower chutes 140 are less than or greater than 7, and it should be that all of these matters belong to the scope of rights of the present invention.

For your reference, the upper chute 130 and the lower chute 140 are duct members that constitute a funnel structure, and a plate or structure for supporting them belongs to the upper chute 130 and the lower chute 140. Descriptions thereof will be omitted.

Meanwhile, the washed rice delivery unit 150 is disposed between the upper chute 130 and the lower chute 140, and at least a part of the washed rice delivery unit 150 is movable, and the washed rice delivery unit 150 delivers washed rice at the upper chute 130 to the lower chute 140 simultaneously. That is, due to the action of the washed rice delivery unit 150, for example, washed rice falling from the upper chutes 130 having seven holes may be supplied to seven containers 20 through the lower chutes 140 having seven holes.

The washed rice delivery unit 150 that performs this role is disposed in the lower region of the upper chutes 130 while corresponding to each of the upper chutes 130, and may include a plurality of washed rice storing units 151 in which washed rice falling from the upper chutes 130 is temporarily stored, an integrated volumetric unit 160 that is disposed at a lower part of the plurality of washed rice storing units 151, moves linearly and delivers washed rice at the washed rice storing units 151 to the lower chutes 140, and a volumetric unit driving unit 170 that is connected to the integrated volumetric unit 160 and drives the integrated volumetric unit 160 linearly.

In addition, the washed rice delivery unit 150 may further include a washed rice delivery plate 181 disposed between the integrated volumetric unit 160 and the lower chutes 140 and including a plurality of washed rice delivery holes 181a through which the washed rice at the integrated volumetric unit 160 is delivered to the lower chutes 140, a unit guide 182 that is disposed on the washed rice delivery plate 181 and guides linear movement of the integrated volumetric unit 160, and a stopper 183 that is disposed in front of or in rear of the unit guide 182 and limits movement of the integrated volumetric unit 160. The stopper 183 is optionally provided and is not necessarily applied to the present invention.

The washed rice storing unit 151 that is a kind of tray with pierced top and bottom constitutes a place in which washed rice falling from the upper chutes 130 is temporarily stored. The washed rice storing units 151 are disposed in a lower region of the upper chutes 130 while respectively corresponding to the upper chutes 130 and thus, the number of washed rice storing units 151 is 7. The washed rice storing unit 151 is inclined toward the bottom so that washed rice can be well discharged.

The integrated volumetric unit 160 is disposed at a lower part of the washed rice storing unit 151, moves linearly and delivers washed rice at the washed rice storing unit 151 to the lower chutes 140. In the present embodiment, the integrated volumetric unit 160 has 7 holes, for example. Thus, the integrated volumetric unit 160 may supply washed rice to 7 containers 20 at one time simultaneously. Thus, workability is very high so that productivity can be enhanced.

In particular, because the integrated volumetric unit 160 having a simple structure is applied, disassembly and assembly becomes easier compared to the related art and easy cleaning can be performed and thus, an overall set up time can be reduced like that a production preparation time can be remarkably reduced.

The integrated volumetric unit 160 includes a unit body 161 which divides a space in which a fixed amount of washed rice is individually stored, having a plurality of spacing adjusters 162 arranged to be adjustable therein and of which upper and lower parts are perforated, an upper plate 164 that is detachably coupled to the upper part of the unit body 161 and has a plurality of upper through holes 164a formed therein, and a lower plate 165 that is detachably coupled to the lower part of the unit body 161 and has a plurality of lower through holes 165a formed therein.

Each of the plurality of spacing adjusters 162 may include a plurality of pieces. Thus, when the spacing adjusters 162 are replaced, a space between the spacing adjusters 162 may be adjusted.

A head portion 166 is coupled to one end of the unit body 161. A spacing adjustment bolt 167 that adjusts a distance between the head portion 166 and the unit body 161 is disposed between the head portion 166 and the unit body 161. Thus, volume adjustment can be performed at once by tightening or loosening the spacing adjustment bolt 167. Thus, workability can be greatly enhanced.

A driving unit connection bracket 168 is provided at the other end of the unit body 161. The volumetric unit driving unit 170 may be easily connected through the driving unit connection bracket 168. Of course, the supply apparatus 100 for a fixed amount of washed rice according to the present embodiment has an easily detachable structure and thus can easily be cleaned.

The volumetric unit driving unit 170 is connected to the integrated volumetric unit 160 and linearly drives the integrated volumetric unit 160, i.e., drives the integrated volumetric unit 160 forward/backward. The volumetric unit driving unit 170 may be a cylinder, and the integrated volumetric unit 160 may be better moved forward/backward by the action of the unit guide 182. In the process of moving the integrated volumetric unit 160 forward and backward, the integrated volumetric unit 160 may communicate or not communicate with the washed rice delivery hole 181a of the washed rice delivery plate 181, and when communicating, washed rice may fall into the lower chutes 140 through the washed rice delivery hole 181a.

Meanwhile, a device controller 190 as a unit for controlling the supply of a fixed amount of washed rice to the container 20 is further mounted on the apparatus 100 for supplying a fixed amount of washed rice according to the present embodiment.

The device controller 190 controls an operation of the washed rice delivery unit 150 with respect to the volumetric unit driving unit 170 so that a fixed amount of washed rice in the washed rice hopper 120 may be supplied to the container 20 through the upper chutes 130, the washed rice delivery unit 150, and the lower chutes 140.

The device controller 190 that performs this role may include a central processing unit (CPU) 191, memory 192, and a support circuit 193.

In the present embodiment, the CPU 191 may be one of various computer processors that can be industrially applied to control the operation of the volumetric unit driving unit 170.

The memory 192 is connected to the CPU 191. The memory 192, which is a computer-readable recording medium, may be locally or remotely installed, and may be at least one type of memory that can easily be used, for example, random access memory (RAM), read-only memory (ROM), a floppy disk, a hard disk or an arbitrary digital storage form.

The support circuit 193 is combined with the CPU 191 and supports the typical operation of the processor. The support circuit 193 may include a cache, a power supply, a clock circuit, an input/output circuit, a sub-system, or the like.

In the present embodiment, the device controller 190 controls the operation of the volumetric unit driving unit 170 so that a fixed amount of washed rice in the washed rice hopper 120 may be supplied to the container 20 through the upper chutes 130, the washed rice delivery unit 150, and the lower chutes 140. At this time, a series of processes, etc., in which the device controller 190 controls the operation of the volumetric unit driving unit 170 may be stored in the memory 192. Typically, software routines may be stored in the memory 192. The software routines may also be stored or executed by another CPU (not shown).

Although the process according to the present invention has been described as being executed by software routines, it is also possible that at least some of the processes according to the present invention are performed by hardware. As such, the processes of the present invention may be implemented as software running on a computer system, as hardware such as an integrated circuit, or as a combination of software and hardware.

Through this configuration, when the washed rice is supplied to the linear feeder 101, washed rice is stored uniformly in the washed rice hopper 120 without being tilted due to the action of the linear feeder 101, and then, as the integrated volumetric unit 160 is driven forward and backward by the volumetric unit driving unit 170 of the washed rice delivery unit 150, a fixed amount of washed rice of the washed rice hopper 120 may be supplied to instant rice containers 20 through the upper chutes 130, the lower chutes 140, the washed rice storing unit 151, the integrated volumetric unit 160, the washed rice delivery hole 181a of the washed rice delivery plate 181, and the lower chutes 140.

According to the present embodiment, which operates with the structure described above, a fixed amount of washed rice can be filled in and supplied to the container 20 and a complicated structure according to the related art can be efficiently and compactly simplified so that disassembly and assembly becomes easier and easy cleaning can be performed and thus an overall set up time can be reduced such that a production preparation time can be remarkably reduced.

As such, the present invention is not limited to the described embodiments, and it is obvious to those skilled in the art that various modifications and changes can be made without departing from the spirit and scope of the present invention. Therefore, it should be said that such modifications or variations fall within the scope of the claims of the present invention.

### EXPLANATION OF REFERENCE NUMERALS

1: instant rice container insertion unit
2: instant rice container separation device
3: container presence detection device
4: container foreign substance removal device
5: washed rice chopping device
6: container discharge device
10: tray
20: container
30: tray conveyor
40: system body
60: steam pressurizing and sterilization device
70: cooking device
81: sealing device
82: treatment device
83: packaging device
100: supply apparatus for fixed amount of washed rice
110: apparatus body
120: washed rice hopper
130: upper chute
140: lower chute
150: washed rice delivery unit
151: washed rice storing unit
160: integrated volumetric unit
161: unit body
162: spacing adjuster
164: upper plate
164a: upper through hole
165: lower plate
165a: lower through hole
166: head portion
167: spacing adjustment bolt
168: driving unit connection bracket
170: volumetric unit driving unit
181: washed rice delivery plate
181a: washed rice delivery hole
182: unit guide
183: stopper
190: device controller

1. A supply apparatus for a fixed amount of washed rice, the supply apparatus comprising:
a washed rice hopper provided at one side of an apparatus body and forming a place where washed rice is stored therein;
a plurality of upper chutes which are provided in a lower region of the washed rice hopper and through which the washed rice in the washed rice hopper falls individually;
a plurality of lower chutes provided in a same number as the upper chutes, spaced apart from each other in a lower region of the upper chutes, and supplying the washed rice falling from the upper chutes to instant rice containers; and
a washed rice delivery unit which is disposed between the upper chutes and the lower chutes, is at least partially movable, and simultaneously delivers the washed rice on the upper chute sides to the lower chutes.

2. The supply apparatus of claim 1, wherein the washed rice delivery unit comprises:
a plurality of washed rice storing units which are arranged in a lower region of the upper chutes while respectively corresponding to the upper chutes and in which washed rice falling from the upper chutes is temporarily stored;
an integrated volumetric unit which is disposed in a lower part of the washed rice storing unit, linearly moves and delivers washed rice at the washed rice storing unit to the lower chutes; and
a volumetric unit driving unit connected to the integrated volumetric unit and drives the integrated volumetric unit linearly.

3. The supply apparatus of claim 2, wherein the washed rice delivery unit
further comprises a washed rice delivery plate which is arranged between the integrated volumetric unit and the lower chutes and comprises a plurality of washed rice delivery holes through which washed rice at the integrated volumetric unit is delivered to the lower chutes.

4. The supply apparatus of claim 3, wherein the washed rice delivery unit
further comprises a unit guide which is disposed on the washed rice delivery plate and guides linear movement of the integrated volumetric unit.

5. The supply apparatus of claim 4, wherein the washed rice delivery unit
further comprises a stopper which is disposed in front of or in rear of the unit guide and limits movement of the integrated volumetric unit.

6. The supply apparatus of claim 2, wherein the integrated volumetric unit
comprises:
a unit body which divides a space in which a fixed amount of washed rice is individually stored, has a plurality of spacing adjusters arranged to be adjustable therein and of which upper and lower parts are perforated;
an upper plate which is detachably coupled to the upper part of the unit body and has a plurality of upper through holes formed therein; and
a lower plate which is detachably coupled to the lower part of the unit body and has a plurality of lower through holes formed therein.

7. The supply apparatus of claim 6, wherein the integrated volumetric unit
further comprises:
a head portion coupled to one end of the unit body; and
a spacing adjustment bolt which is connected to the head portion and the unit body and adjusts a distance between the head portion and the unit body.

8. The supply apparatus of claim 6, wherein the integrated volumetric unit
further comprises a driving unit connection bracket coupled to the other end of the unit body and connected to the volumetric unit driving unit.

9. The supply apparatus of claim 2, further comprising a device controller
controlling an operation of the washed rice delivery unit with respect to the volumetric unit driving unit so that a fixed amount of washed rice in the washed rice hopper can be supplied to the container through the upper chutes, the washed rice delivery unit, and the lower chutes.

10. An instant rice manufacturing system comprising:
a system body; and
a supply apparatus for a fixed amount of washed rice which is provided at one side of the system body and supplies a fixed amount of washed rice into an instant rice container,
wherein the supply apparatus for a fixed amount of washed rice comprises:
a washed rice hopper provided at one side of an apparatus body and forming a place where washed rice is stored therein;
a plurality of upper chutes which are provided in a lower region of the washed rice hopper and through which the washed rice in the washed rice hopper falls individually;
a plurality of lower chutes provided in a same number as the upper chutes, spaced apart from each other in a lower region of the upper chutes, and supplying the washed rice falling from the upper chutes to instant rice containers; and
a washed rice delivery unit which is disposed between the upper chutes and the lower chutes, is at least partially movable, and simultaneously delivers the washed rice on the upper chute sides to the lower chutes.
